(19) United States
(12) Patent Application Publication
(10) Pub. No.: US 2018/0067335 A1
(43) Pub. Date: Mar. 8, 2018

(54) OPTICAL IMAGE STABILIZATION FOR FOLDED OPTICS CAMERA MODULES

(71) Applicant: Google Inc., Mountain View, CA (US)

(72) Inventors: Xi Chen, Sunnyvale, CA (US); Lu Gao, Cupertino, CA (US); Mehrdad Roosta, Campbell, CA (US)

(21) Appl. No.: 15/257,999

(22) Filed: Sep. 7, 2016

(51) Int. Cl. G02B 27/64; G02B 13/00; G02B 7/182; G03B 5/00; G02B 13/02; H04N 5/232

(52) U.S. Cl. CPC G02B 27/646; G02B 13/0065; G02B 7/1822; G03B 5/00; G03B 2205/003; H04N 5/23287; H04N 5/23283; G03B 2205/0023; G02B 13/02

(57) ABSTRACT

In some implementations, a camera module includes an image sensor, a lens assembly comprising a first portion configured to receive light along a first optical axis and a second portion that includes a plurality of lens elements that share a second optical axis that is different from the first optical axis, a reflective element arranged to alter a path of light entering the camera in a direction along the first optical axis to a direction along the second optical axis, at least two independent actuators configured to tilt the reflective element about a pivot point, and one or more resilient elements configured to bias a position of the reflective element.

### BACKGROUND

The present specification relates to optical image stabilization (OIS) for mobile devices, including camera modules that utilize telephoto lens assemblies with folded optics.

Telephoto lenses provide a long focal length and allow users to take photographs of distant objects. Folded optics assist with packaging restrictions faced by long optical assemblies such as telephoto lenses. The long focal length of telephoto lenses amplifies the effect of hand jitters and resulting image shifts. OIS compensates for image shifts by varying the optical path to the sensor.

### SUMMARY

Telephoto lenses resolve fine features of distant objects. However, due to the long focal length of telephoto lenses, movement of a camera when hand-held causes larger image shift, or blur, in cameras using telephoto lenses than cameras using other lens assemblies, such as wide angle lenses. Image shift due to camera module tilt is a function of the tilt angle and the focal length, or the distance between the lens and the image sensor of the camera when the subject is in focus. Telephoto lenses have longer focal lengths than wide angle lenses with the same optical format, and thus the magnitude of image shift due to hand shaking is larger with a telephoto lens than with a wide angle lens. Optical image stabilization (OIS) can compensate for the movement of the camera module to reduce blur in the images created.

A folded camera helps make telephoto lenses useable in a thin package. Folded optics assemblies use a reflective element to redirect light incident along a first optical axis to a direction along a second optical axis. Folding or bending the optical path directs the long dimension of the lens assembly to the long dimension of the phone or tablet, without increasing the thickness of the assembly.

In some systems, OIS is implemented in mobile device cameras by linearly translating the lens in perpendicular directions along the plane of the camera module. In these systems, the linear translations offset the image shift induced by camera movement. A commonly used actuating system is the voice coil motor (VCM) based OIS actuator, which uses magnets, coils, and other related components. A similar design used in a telephoto assembly—even an assembly using folded optics—will significantly increase the thickness of the lens assembly: an undesirable effect for the construction of modern mobile devices, such as mobile phones and tablet computers, which are becoming increasingly thin. Implementation of the linear OIS technique may diminish the form factor benefits a folded camera is intended to provide.

In some implementations, to effectively provide OIS while preserving a very small thickness, a telephoto lens module can be configured to tilt a reflective element to compensate for the movement of the module to reduce image blur. By tilting the reflective element instead of translating the entire camera module, the proposed system provides OIS in a thin package.

Multiple independently-driven actuators control a reflective element within the folded optics to compensate for movement of the camera module. Each actuator can be controlled independently of the other actuators, and tilt the reflective element about a pivot point. For example, when voice coil actuators or other actuators are used, the actuators can be decoupled from each other magnetically, so that the magnetic coils drive different magnets. In some implementations, the actuators tilt the reflective element about substantially orthogonal axes. By tilting only the reflective element in response to the movement of the camera module, the need for a relatively large linear OIS system that translates the entire lens assembly is removed. Additionally, the movement of the reflective element allows for corrections for images with subjects within a near distance and a far distance to the camera module.

The reflective element can tilted about a pivot point such that the pivot point is fixed and is the center of movement for the reflective element. Biasing elements can be used to control a neutral position of the reflective element, ensure the return of the reflective element to the neutral position, and calibrate the neutral position.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram illustrating a mobile device including a camera module with folded optics.

FIG. 2 is a diagram illustrating the camera module with folded optics of FIG. 1.

FIGS. 3A-6 are diagrams of example configurations of reflective element assemblies that alter a path of light entering the camera module described with reference to FIGS. 1-2.

FIG. 7 is a diagram illustrating an example system for controlling the reflective element assemblies described with reference to FIGS. 3A-6.

FIG. 8 is a flowchart illustrating an example process in which the reflective element assemblies described with reference to FIGS. 3A-6 alter a path of light entering the camera module described with reference to FIGS. 1-2.

Like reference numbers and designations in the various drawings indicate like elements. The components shown here, their connections and relationships, and their functions, are meant to be exemplary only, and are not meant to limit the implementations described and/or claimed in this document.

### DETAILED DESCRIPTION

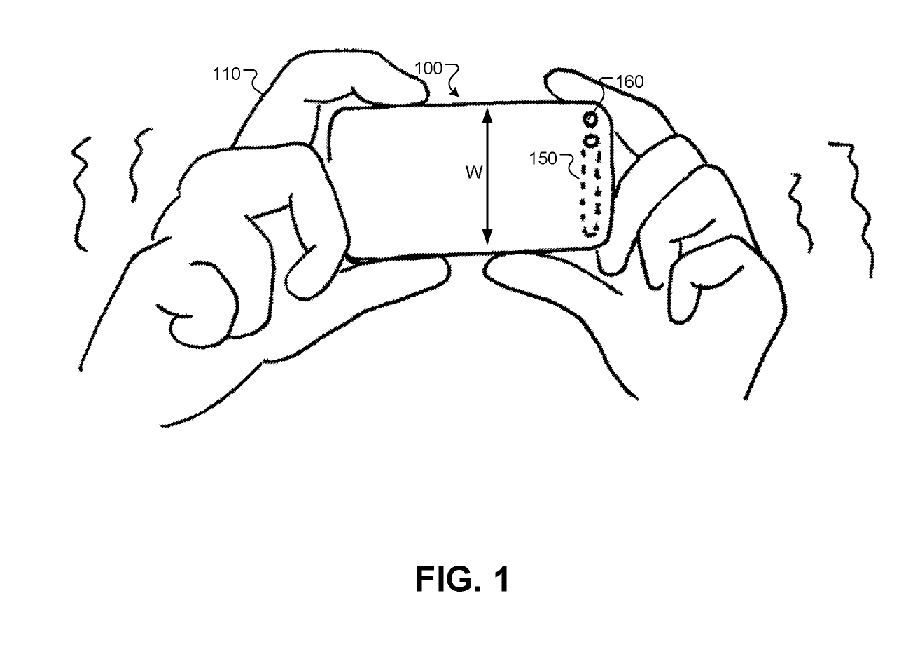

FIG. 1 is a diagram illustrating a mobile device 100 including a camera module 150 with folded optics. In this example, the mobile device 100 is a smartphone with an advanced mobile operating system that combines features of a personal computer with other features useful for mobile use, such as image processing. The mobile device 100 is configured to allow a user 110 to take photographs using the camera module 150. The mobile device 100 can be various mobile devices, such as a tablet, laptop, etc. The mobile device 100 includes essential elements of a computer, such as a processor, a storage device, one or more memory devices, etc.

In the example of FIG. 1, the camera module 150 includes a telephoto lens assembly. Generally, telephoto lenses are lenses with focal lengths longer than the diagonal size of the image sensor of the camera. Generally telephoto lenses have physical lengths shorter than the focal length. The thickness of devices incorporating telephoto lens assemblies are typically dependent on the length of the telephoto lens assembly used. Keeping a mobile device thin is an important design constraint on modern mobile devices, such as smartphones; as such, long telephoto lens assemblies that increase the thickness of a mobile device (e.g., in a direction perpendicular to the screen of the mobile device) are not desirable.

In the example of FIG. 1, the camera module 150 includes a telephoto lens assembly that incorporates folded optics, which help limit the overall thickness of the camera module 150. Folded optical systems alter the direction of incident light, for example, by receiving light along an incident axis, and directing it along a second axis that is perpendicular to the incident axis. An advantage of using folded optics is increasing the length of the optical path, or path of light, without increasing the size of the system. Because of the 90-degree bend in the optical path, most of the lens elements can be placed along a width direction, W, of the mobile device, rather than the perpendicular thickness direction that designers often attempt to minimize. The thickness of the camera module 150 can be reduced with respect to a camera module that does not use folded optics and includes a telephoto lens with the same focal length.

In typical systems, the thickness of a camera module dictates the thickness of a mobile device. In this example, because the camera module 150 uses folded optics, the thickness of the mobile device 100 is dependent on the size of a reflective element used in the folded optics system to alter the path of light incident to the camera module 150. As indicated by the dotted lines in FIG. 1, the camera module 150 with the telephoto lens extends along a width of the mobile device 110 instead of a depth or thickness of the device.

The long focal length of the telephoto lens assembly amplifies the magnitude of image shift due to hand jitter. Hand jitter is caused by the movement of a user, such as user 110, when taking a picture with a camera. Even if the user 110 is unaware of the movement, their hand can be continually moving. The movements are relatively small, but with a telephoto lens, even a minor amount of jitter can produce a large amount of image shift in a resulting photo taken using the camera module 150.

In some implementations, the mobile device 100 can include a camera module 160 that includes a camera module with a second lens assembly, such as a wide angle lens assembly, in addition to the telephoto lens assembly. The camera module 160 can provide a different focal length and allow the user 110 to take a larger variety of photos on the same device. Wide-angle lenses have focal lengths substantially smaller than the focal length of a normal lens, and allows more of the scene being photographed to be included.

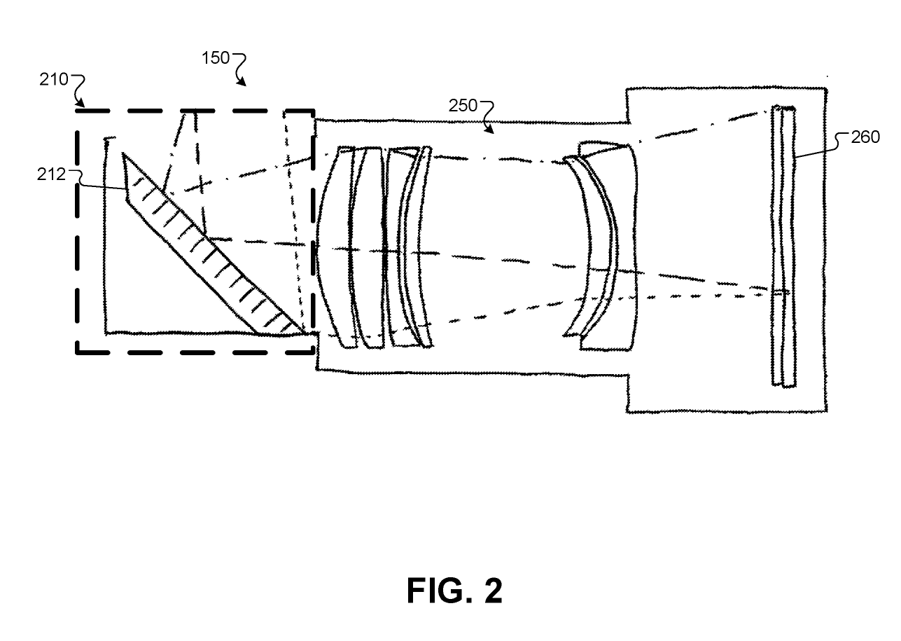

FIG. 2 is a diagram illustrating the camera module 150 of FIG. 1. The camera module 150 includes a reflective element assembly 210, indicated by the box formed with dashed lines, a lens assembly 250, and an image sensor 260. The reflective element assembly 210 includes a reflective element 212. In this example, the reflective element 212 is a mirror. In some implementations, the reflective element 212 can be a prism, or another reflective element.

The reflective element 212 has a reflecting surface that changes a direction of incident light from a first optical axis to a second optical axis. The reflecting element 212 controls an angle of the second optical axis from the first optical axis. The second optical axis can be oriented to satisfy a predetermined focal length or form factor of the camera module 150. For example, the reflective element 212 can be oriented at an angle of 45° to change the path of incident light to travel through the lens assembly 250 and into the image sensor 260. This can represent a neutral position of the reflective element 212 before any motion compensation or image stabilization occurs. As discussed below, the reflective element 212 can be tilted to various angles that deviate from the neutral position.

The lens assembly 250 includes multiple lens elements with varying refractive power. In this example, the lens assembly 250 includes six refractive lens elements. However, more or fewer refractive lens elements can be used. The refractive lens elements of the lens assembly 250 can be composed of various plastic materials, glass, etc. The refractive lens elements can be composed of materials with different optical characteristics, such as different Abbe numbers, different refractive indices, etc.

The refractive lens elements can be selected such that the refractive power distribution of the lens assembly 250 satisfies a predetermined focal length requirement. In some implementations, the lens assembly 250 can correct for chromatic aberrations, or the effect from dispersion in which a lens assembly fails to focus all colors to the same convergence point. In some implementations, the lens assembly 250 can correct for Petzal field curvature, or an aberration in which a flat object normal to the optical axis cannot be brought properly into focus.

The image sensor 260 detects and conveys information that constitutes an image. The image sensor 260 converts the attenuation, or gradual loss in intensity, of light waves into signals that convey the information. In general, digital cameras use a flat sensor. In some implementations, camera modules can use curved sensors, which allow a shorter and smaller diameter of lens and reduces the number of elements and components needed while providing a greater aperture.

In some implementations, the image sensor 260 is a complementary metal-oxide-semiconductor (CMOS) sensor that incorporates an integrated circuit that reduces cost of production. CMOS image sensors have amplifiers for each pixel of an image and can use back-side illumination to increase the number of photons that hit the photodiode of the sensor. In some implementations, the image sensor 260 is a charge-coupled device (CCD) sensor. CCD sensors are analog devices that hold electrical charge in each pixel of an image.

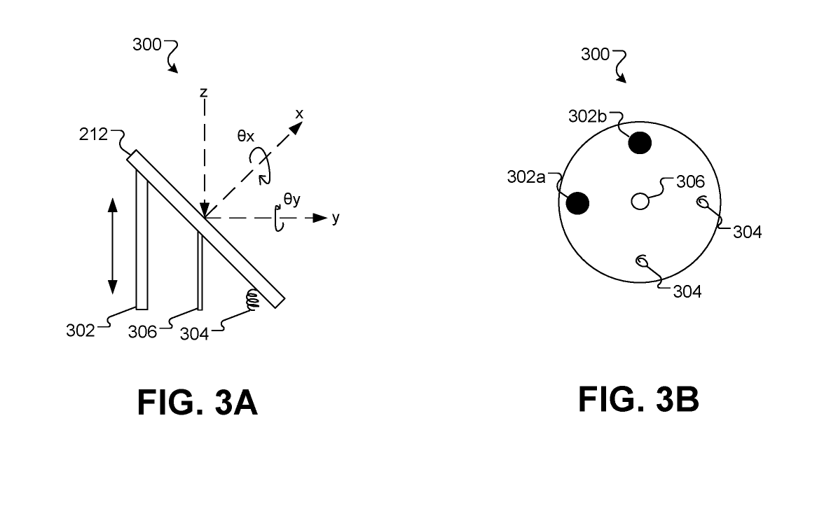

FIGS. 3A-3B are diagrams of an example configuration of reflective element assembly 210 that alters a path of light entering the camera module described with reference to FIGS. 1-2.

FIG. 3A illustrates a side view of a reflective element assembly 300. FIG. 3B illustrates a top view of the reflective element assembly 300. The reflective element assembly 300 includes a reflective element 212, two actuators 302a-302b, two biasing elements 304, and a pivot point 306.

In this example, the reflective element 212 is a mirror. The reflective element 212 is coupled to the pivot point 306, around which the reflective element 212 is tilted to alter a direction of incident light from a first optical axis to a second optical axis.

In this example, the reflective element 212 is circular. In some implementations, the reflective element 212 can have any of various shapes, such as rectangular, triangular, etc.

In some implementations, the reflective element 212 can be constructed by coating an injection molded plastic part. For example, a mirror coat can be applied to an injection molded plastic part, and the part can be used as the reflective element 212. In some implementations, the reflective element 212 can be constructed by coating a strengthened molded glass part. Through the manufacturing process of coating the injection molded plastic part or the strengthened molded glass part with a reflective coat, the resultant reflective element 212 has greater flexural strength relative to a standard glass reflective element, and can survive shocks or drops suffered by the reflective element assembly 300.

In some implementations, the reflective element 212 is manufactured such that the thickness of the reflective element 212 is large enough to provide stiffness and a resonant frequency above a certain threshold, but thin enough to provide form factor benefits over a traditional OIS system. For example, the reflective element 212 can be manufactured such that the reflective element has a resonant frequency above 200 Hz.

The pivot point 306 can be provided by a mechanical pivot. In some implementations, the pivot point 306 is located at the back side of the reflective element 212, where the reflective element 212 rests on or articulates against the end of a post 305 or other structure. In some implementations, the pivot point 306 is located on a pin, an arm, or another structure that supports or engages the reflective element 212. A structure that the reflective element pivots on can be mounted between the reflective element 212 and a mechanical datum, such as a fixed surface of the camera module that includes the reflective element assembly 300. For example, the post or other structure that provides the pivot point can be mounted on a bottom surface of the camera module 150.

In this example, the pivot point 306 is in the center of the reflective element 212. Other implementations, can place the pivot point 306 at other locations on the reflective element 212. For example, the pivot point 306 can be placed at an edge of the reflective element 212.

The reflective element 212 is tilted about the pivot point 306 by the actuators 302a-302b. Each of the actuators 302a-302b can be controlled separately from the other. For example, one independently controlled actuator can be actuated while the other is not actuated. In another example, one independently controlled actuator can be actuated in a positive direction while the other can be actuated in the negative direction. The actuators 302a-302b can be actuated at different times, and can be operated asynchronously from each other. The actuators 302 can be arranged to tilt the reflective element 212 about orthogonal axes, as discussed further below. The actuators 302 may move elements along linear axes, and the elements may engage the reflective element 212 to cause a tilt. In some implementations, the linear axes of movement are parallel axes spaced apart at different positions of the reflective element 212. The actuators 302a-302b each provide linear movement of a component along an axis, and the components engage a back side of the reflective element 212.

When actuators using magnetic drives are used, each actuator may interact with a separate magnet. For example, when voice coil actuators are used, each actuator may include a separate voice coil and a separate magnet. Each actuator may move its corresponding magnet along an axis, and the motion can be transferred through a post or other component to the back of the reflective element 212 to cause tilt. In this manner, the actuators move different magnets, and cause translation of their respective magnets along different axes. The voice coil of each actuator is adjacent its own magnet, but much farther from the magnets of other actuators, and so does not move the magnets of the other actuators. Each actuator receives a separate control signal configured to control the actuator to move its own magnet separately from the other magnets.

The actuators 302 engage the reflective element 212 at different positions that are spaced out on the reflective element 212. In some implementations, the actuators 302 are spaced evenly around the reflective element 212 and engage the reflective element 212 at points at the edge of the reflective element 212.

The actuators 302a-302b tilt the reflective element 212 about the pivot point 306 based on sensor data indicating movement of the camera module that contains the reflective element assembly 300. The actuators 302 provide varying amounts and directions of tilt of the reflective element 212 from its neutral position. Movement of the camera module is detected by one or more sensors, such as gyroscopes, inertial motion units, and/or accelerometers, and control signals are provided to the actuators 302 to dynamically adjust the tilt position to compensate for camera movement in real time.

In the example of FIGS. 3A-3B, the actuators 302a-302b are arranged to tilt the reflective element 212 about perpendicular axes. The actuators 302a-302b engage the reflective element 212 at locations that are offset from the pivot point 306. The actuator 302a and one biasing element 304 engage the reflective element 212 along the y axis shown in FIG. 3B, and can engage the back of the reflective element 212 in the areas shown. Movement of the actuator 302a causes the reflective element 212 to tilt about the x axis. Similarly, the actuator 302b and the biasing element 304 engage the reflective element 212 along the x axis, so that movement of the actuator 302b causes tilting about the y axis.

In some implementations, the actuators 302a-302b are positioned equidistant from the center of the reflective element 212. In some implementations, the actuators 302a-302b are positioned equidistant from the pivot point 306. For example, the actuators 302a-302b can be positioned on perpendicular axes, each 10 mm from the pivot point 306. The actuators 302a-302b can engage the back side of the reflective element 212 at an outer region of the reflective element 212, for example, at an edge, or an edge region such as at a distance of half the radius of the reflective element 212 or greater from the pivot point.

In some implementations, the actuators 302a-302b are linear actuators. In some implementations, the actuators 302a-302b are VCM based actuators. In some implementations, the actuators 302a-302b are piezoelectric actuators. Piezoelectric actuators use piezoelectric materials, e.g., certain solid materials in which electric charge accumulates in response to applied mechanical stress. Typically, very high electric fields correspond to relatively tiny changes in the width of the material; this allows piezoelectric materials to position objects with high accuracy, and is a benefit of using piezoelectric materials as actuators. In some implementations, the actuators 302a-302b are various other actuators that can tilt the reflective element 212, such as rotary actuators, pneumatic actuators, etc.

In some implementations, the actuators 302a-302b include encoders, or devices that convert information from one format to another that provide position and/or speed feedback. For example, the actuators 302a-302b can include Hall effect sensors. Hall effect sensors are transducers that vary output voltage in response to a magnetic field, and can be used for positioning and speed detection. In some implementations, the actuators 302a-302b include any of various encoders that provide position and/or velocity feedback.

The actuators 302a-302b actuate the mirror in two orthogonal directions, providing two degrees of freedom, or directions in which independent motion can occur. Each of the actuators 302a-302b can move normally to the mechanical datum, or plane of the camera module of which the reflective assembly 300 is a part. For example, each of the actuators 302a-302b can move along a z axis of the reflective element 212.

In some implementations, the actuators 302a-302b can return the reflective element 212 to a neutral position. For example, the actuators 302a-302b can tilt the reflective element 212 to return to a neutral position based on feedback from encoders of the respective actuators 302a-302b. In some implementations, the biasing elements 304 exert a force that fully or partially returns the reflective element 212 to the neutral position. The biasing elements 304 provide a mechanical preload on the reflective element 212.

The biasing elements 304 can bias a position of the reflective element 212. For example, the biasing elements 304 can exert a force on the reflective element 212 that tends to return the reflective element to its neutral position, e.g., a position where the reflective plane of the reflective element 212 is angled at 45 degrees from the optical axis that light enters the camera module. In some implementations, the biasing elements 304 are resilient springs. In some implementations, the biasing elements 304 are flexures. Other biasing elements may additionally or alternatively be used.

In this example, the biasing elements 304 are placed along axes perpendicular to each other. Each biasing element 304 is placed directly opposite from one of the actuators 302a-302b, with the pivot point 306 in between. The opposite positioning of the biasing elements 304 allows each of the biasing elements 304 to counteract the movement of the actuators 302a-302b and return the reflective element 212 to a neutral position. For example, the actuators 302a-302b can tilt the reflective element 212 and the biasing elements 304 can return the reflective element 212 to the neutral position without further control of the actuators 302a-302b.

In some implementations, the biasing elements 304 are positioned equidistant from the center for the reflective element 212. In some implementations, the biasing elements 304 are positioned equidistant from the pivot point 306. For example, the biasing elements 304 can be positioned on perpendicular axes, each 10 mm from the pivot point 306. In some implementations, the biasing elements 304 can be positioned at the same distance from the center of the reflective element 212 or the pivot point 306 as the actuators 302a-302b. For example, the actuators 302a-302b and the biasing elements 304 can be placed at 90° intervals around the edge of the reflective element 212, 12 mm from the pivot point 306.

The biasing elements 304 may exert a force in a single direction through the range of tilt. For example, in FIGS. 3A-3B, the biasing elements 304 may consistently push upward along the z axis. The actuators 302a-302b may also vary their positions to adjust the tilt, but need not pull down the reflective element 212 since the biasing elements 304 may be configured to push the reflective element past the neutral position unless impeded by the actuators 302a-302b. As another example, the biasing elements 304 may exert different directions of force depending on the position of the reflective element 212. A biasing element 304 may include one or more springs arranged to, for example, push upward at an edge if the angle exceeds 45 degrees and pull down if the angle is less than 45 degrees, thus exerting a force to counteract any deviation from the neutral position along an axis. In a similar manner, the movement of the actuators 302a-302b may both push and pull the reflective element 212.

In some implementations, the biasing elements 304 allow positioning and set-up of components within the reflective element assembly 300. For example, the biasing elements 304 can calibrate a neutral position of the reflective element 212 relative to the manufacturer's specifications. In some implementations, calibration data is used to adjust and/or position the biasing elements 304. For example, calibration data from the manufacturer of the reflective element assembly 300 can be used to adjust the biasing elements 304 such that the reflective element 212 is in a desired neutral position when the actuators 302a-302b are not displaced from their neutral or central positions.

In some implementations, the biasing elements 304 can dynamically bias or calibrate the position of the reflective element 212. For example, a spring and a linear actuator can be adjusted upon turn-on of a camera module containing the reflective element assembly 300 and detection of the current position of the reflective element 212 relative to a desired starting position.

In some implementations, a neutral position of the reflective element 212 is not in the center of range of actuation for one or more of the actuators 302a-302b. For example, the actuators 302a-302b can be linear actuators, and the neutral position of the reflective element 212 is not in the center of the range of actuation for the actuators 302a-302b. In this example, when the actuators 302a-302b are not actuated, the reflective element 212 may not return to the neutral position using the actuators 302a-302b alone: the biasing elements 304 can provide a preload or a counteracting force to the force provided by the actuators 302a-302b to return the reflective element 212 to the neutral position.

In some implementations, the biasing elements 304 are omitted. For example, if the actuators 302a-302b are piezoelectric actuators capable of being precisely and accurately controlled to return to a neutral position, the biasing elements 304 can be omitted. Other linear actuators can be used in the same way to actively return the reflective element 212 to its neutral position in the absence of biasing elements.

Typical OIS VCM actuators are designed for a particular tilt correction for camera movement by translating a camera module linearly along two orthogonal axes. For example, a typical OIS VCM actuator system in a camera module can be designed for ±1° tilt correction, which requires about ±100 μm stroke range for each of the VCM actuators.

The independently controlled actuator OIS technique tilts a reflective element within a lens assembly of a camera module around two orthogonal axes to correct for camera movement. When the reflective element 212 is rotated by ex about the x-axis, the incoming light ray's direction vector, e.g., k-vector, κ=[kₓ, k_{y}, k_{z}] is changed to κᵣₓ by the mirror. The reflected light ray's k-vector can be calculated as shown in Equation 1, below:

κᵣₓ=[kₓ;−2 cos(θₓ)sin(θₓ)k_{y}+(cos²(θₓ)−sin²(θₓ))k_{z};(cos²(θₓ)−sin²(θₓ))k_{y}+2 cos(θₓ)sin(θₓ)k_{z}] (1)

For small angle rotation, θx≈x, and the reflected light ray's k-vector can be simplified as shown in Equation 2, below:

κᵣₓ=[kₓ;−2θₓk_{y}+k_{z};k_{y}+2θₓk_{z}] (2)

The image shift between the incident light ray and the reflected light ray around the x-axis for line-of-sight can be calculated by setting κ=[0, 0, 1]. The resulting image shift on the plane of the camera sensor due to mirror tilt around the x-axis is shown in Equation 3, below:

ε_{z}=2fθₓ (3)

where f is the effective focal length of the lens. The image shift ε_{z} due to mirror tilt around the x-axis has units of distance, and is a shift along the z-axis. To counteract the image shift ε_{z} using a traditional OIS system, the reflective element 212 is moved linearly along the z-axis by the same distance as the image shift, in the opposite direction. As shown by Equation 3, the image shift ε_{z} is a function of twice the rotation ex around the x-axis. Therefore, corrections for tilting of the camera module around the x-axis using the independently controlled actuator OIS technique require tilting the reflective element by half the angle of the camera module tilt around the y-axis in the same direction as the camera module tilt. In some implementations, providing ±1° tilt correction around the x-axis using the independently controlled actuator OIS technique requires approximately the half of the stroke range as the stroke range of a traditional OIS system in the z-direction.

When the reflective element 212 is rotated by θy about the y-axis, the incoming light ray's direction vector, e.g., k-vector, κ=[kₓ, k_{y}, k_{z}] is changed to κᵣₓ by the mirror. The reflected light ray's k-vector can be calculated as shown in Equation 4, below:

κᵣₓ=[cos²θ_{y}kₓ+sin θ_{y}k_{y}−cos θ sin θ_{y}k_{z};sin(θ_{y})kₓ+cos(θ_{y})k_{z};−cos θ_{y} sin θ_{y}kₓ+cos θ_{y}k_{y}+sin²θ_{y}k_{z}] (4)

For small angle rotation, θy≈y, and the reflected light ray's k-vector can be simplified as shown in Equation 5, below:

κᵣₓ=[kₓ+θ_{y}k_{y}−θ_{y}k_{z};θ_{y}kₓ+k_{z};−θ_{y}kₓ+k_{y}] (5)

The image shift between the incident light ray and the reflected light ray around the y-axis for line-of-sight can be calculated by setting κ=[0, 0, 1]. The resulting image shift on the plane of the camera sensor due to mirror tilt around the y-axis is shown in Equation 6, below:

εₓ=−fθ_{y} (6)

where f is the effective focal length of the lens. The image shift εₓ due to mirror tilt around the y-axis has units of distance, and is a shift along the x-axis. To counteract the image shift εₓ using a traditional OIS system, the reflective element 212 is moved linearly along the x-axis by the same distance as the image shift, in the opposite direction. As shown by Equation 6, the image shift εₓ is a function of twice the rotation θy around the y-axis. Therefore, corrections for tilting of the camera module around the y-axis requires tilting the reflective element by the same amount as the camera module movement around the y-axis in the same direction as the camera module tilt. In some implementations, providing ±1° tilt correction around the y-axis using the independently controlled actuator OIS technique requires approximately the same stroke range as the stroke range of a traditional OIS system in the x-direction.

Thus, the independently controlled actuator OIS technique requires only half of the linear stroke range of a standard OIS system along the x-axis and the full linear stroke range of a standard OIS system along the y-axis.

A lower stroke range requirement corresponds to lower power consumption. Additionally, the reflective element alone weighs less than the entire lens assembly; therefore, the OIS actuators that tilt the reflective element consume less power than the independently controlled OIS actuators that translate the entire lens assembly in typical OIS techniques.

A further advantage of the independently controlled actuator OIS technique is that tilting of the reflective element is independent of object distance. Standard OIS techniques correct image blur by shifting the lens or the sensor. The amount to shift the lens is dependent on object distance, and the closer the object is from the lens, the larger the amount the lens needs to be shifted. Thus, the independently controlled actuator OIS technique is more accurate for image blur correction when the object of the image is close to the lens.

Since the relative tilt angle between a reflective element and the optical axes of a lens in a camera module is critical for line of sight alignment, the tolerance of the relative tilt angle must be small to provide acceptable line of sight alignment. Independently controlled actuators and biasing elements allows the relative tilt angle between the reflective element and the optical axes of the lens to be calibrated and/or compensated for, reducing the need for such a small tolerance.

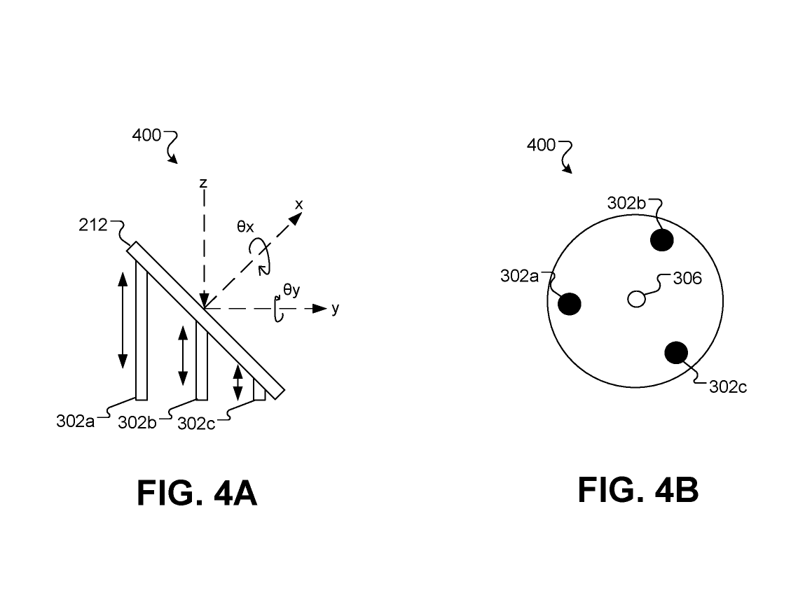

FIGS. 4A-4B are diagrams of an example configuration of reflective element assembly 210 that alters a path of light entering the camera module described with reference to FIGS. 1-2.

FIG. 4A illustrates a side view of a reflective element assembly 400. FIG. 4B illustrates a top view of the reflective element assembly 400. The reflective element assembly 400 includes a reflective element 212, three actuators 302a-302c, and a pivot point 306. The reflective assembly 400 does not include any resilient members or pre-loads to bias the position of the reflective element 212. Instead, the three actuators 302a-302c fully constrain the reflective element 212 in a neutral position. There is also no mechanical post or support for the pivot point 306. Instead, by fully constraining the reflective element 212, the three actuators 302a-302c can be actuated in tandem to tilt the reflective element 212 about the pivot point 306 without a physical support for the pivot point 306.

The reflective element assembly 400 uses three actuators 302a-302c, defining the three points of contact that fully constrain the reflective element 212. By fully constraining the reflective element 212, the reflective element assembly 400 eliminates the need for biasing elements that stabilize and locate the reflective element 212. The actuators 302a-302c can be actuated to tilt the reflective element 212 about the pivot point 306.

In some implementations, the actuators 302a-302c are equally spaced around the edge of the reflective element 212. For example, the three actuators 302a-302c can be spaced at 0°, 120°, and 240° around the reflective element 212. In some implementations, the actuators 302a-302c are arranged such that the actuators 302a-302c are not spaced equally around the edge of the reflective element 212.

In some implementations, the actuators 302a-302c are spaced equally from the pivot point 306. For example, each of the three actuators 302a-302c can be spaced 15 mm from the pivot point 306. In some implementations, the actuators 302a-302c are arranged such that the actuators 302a-302c are not spaced equally from the pivot point 306.

In some implementations, the arrangement of the reflective element assembly 400 allows the reflective element 212 to be translated linearly along a z axis of the reflective element 212. For example, all three of the actuators 302a-302c can be actuated by the same amount to linearly translate the reflective element 212 toward an opening of the camera module through which light is incident. In some implementations, the linear translation of the reflective element 212 can reduce the effect of vignetting, or reduction of an image's brightness or saturation at the periphery compared to the center of the image. In some implementations, the translation of the reflective element 212 may also be used as part of the optical image stabilization for the camera module.

In some implementations, the actuators 302a-302c can be actuated to return the reflective element 212 to a neutral position. For example, the actuators 302a-302c can be controlled to return to a default actuation. In some implementations, the position of the reflective element 212 when none of the actuators 302a-302c have been actuated is the neutral position.

In some implementations, the actuators 302a-302c allow positioning and set-up of components within the reflective element assembly 400. For example, the actuators 302a-302c can be controlled to return to a default position, to alter actuation lengths, etc. to calibrate movement and tilting of the reflective element 212 relative to the manufacturer's specifications. In some implementations, calibration data is used to adjust and/or position the actuators 302a-302c. For example, calibration data from the manufacturer of the reflective element assembly 400 can be used to adjust the actuators 302a-302c such that the reflective element 212 is in a desired neutral position upon turn-on of a camera module containing the reflective element assembly 400.

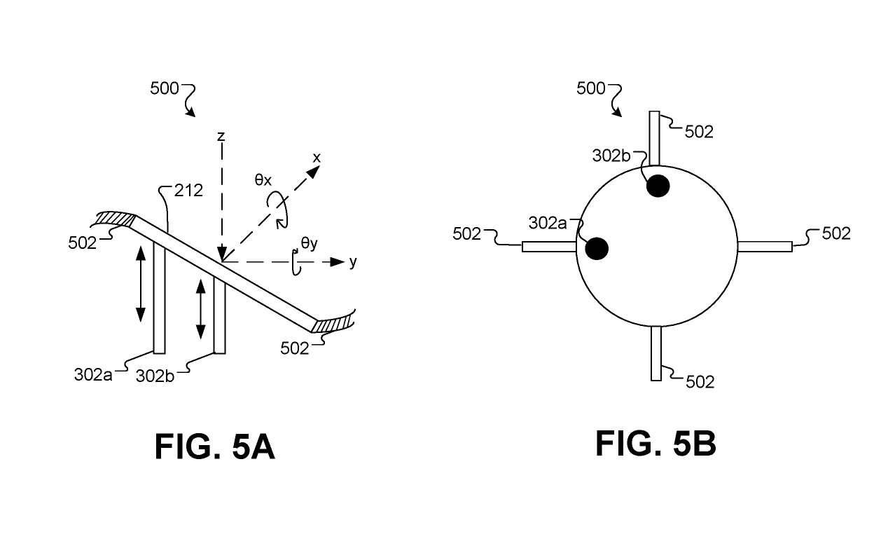

FIGS. 5A-5B are diagrams of an example configuration of reflective element assembly 210 that alters a path of light entering the camera module described with reference to FIGS. 1-2.

FIG. 5A illustrates a side view of a reflective element assembly 500. FIG. 5B illustrates a top view of the reflective element assembly 500. The reflective element assembly 500 includes a reflective element 212, two actuators 302a-302b, and two biasing elements 502.

In this example, the biasing elements 502 are flexures, or elements which allow motion by bending under load. For example, the biasing elements 502 can be resilient elements that connect the reflective element 212 to a camera module that houses the reflective element assembly 500. In some implementations, the biasing elements 502 are resilient springs. In some implementations, the biasing elements 502 are flexures. Other biasing elements may additionally or alternatively be used. In some implementations, the biasing elements 502 are positioned on the edge of the reflective element 212. In some implementations, the biasing elements 502 are positioned at various locations on the reflective element 212.

In this example, the actuators 302a-302b are arranged on perpendicular axes of the reflective element 212. For example, the actuators 302a-302b can be positioned on the x axis and the y axis of the reflective element 212 respectively. In some implementations, the actuators 302a-302b are positioned equidistant from the center of the reflective element 212. For example, the actuators 302a-302b can be positioned on perpendicular axes, each 10 mm from the center of the reflective element 212.

In this example, the biasing elements 502 are also arranged on perpendicular axes of the reflective element 212. For example, the biasing elements 502 can be positioned on the x axis and the y axis of the reflective element 212 respectively. In some implementations, the biasing elements 502 are positioned equidistant from the center of the reflective element 212. For example, the biasing elements 502 can be positioned on perpendicular axes, each 10 mm from the center of the reflective element 212. In some implementations, the biasing elements 502 are placed opposite the actuators 302a-302b. In some implementations, the biasing elements 502 are placed at various points along the edge of the reflective element 212. In some implementations, the biasing elements 502 extend beyond a sensitive region of the reflective element assembly 500 in which light is incident to a sensor, to reduce distortion to the reflective element 212 caused by the biasing elements 502. For example, the biasing elements may extend beyond the edges of the reflective element assembly 500.

The reflective element assembly 500 uses the two actuators 302a-302b and the two biasing elements 502 to allow the reflective element 212 to be tilted about a virtual pivot point. A virtual pivot point is a non-physical point in space about which a system rotates. A reflective element assembly that has a virtual pivot point uses external supports or flexures that may extend beyond the reflective element 212 to allow motion about the center of the reflective element 212 without a physical connection to the center of the reflective element 212. The arrangement of the actuators 302a-302b and the biasing elements 502 allow the reflective element 212 to be tilted about a virtual pivot point when the actuators 302a-302b are actuated. An advantage of using this arrangement is that a physical pivot point can be omitted, reducing cost, the number of parts, and manufacturing complexity.

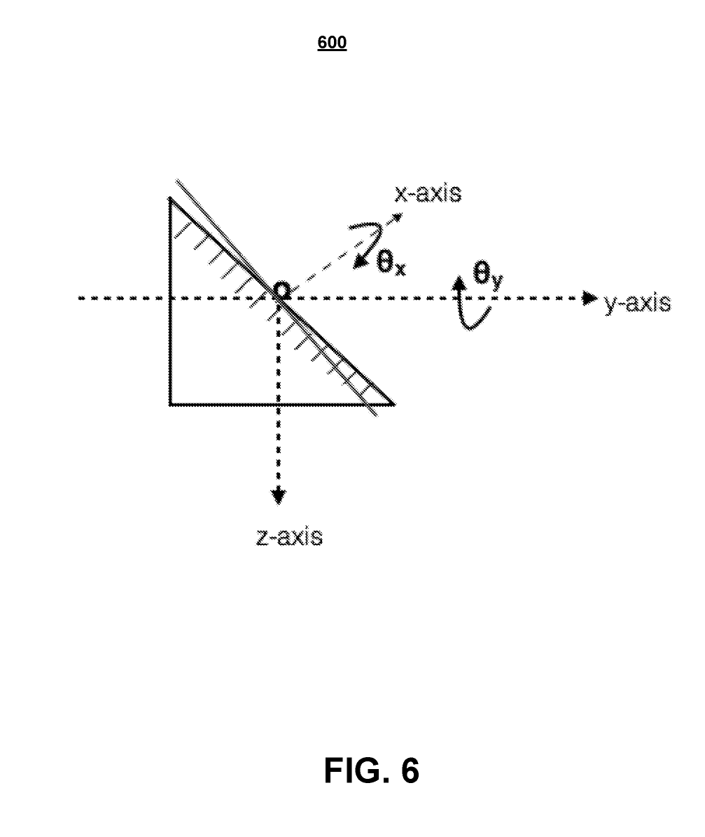

FIG. 6 is a diagram of an example configuration of the reflective element 212 that alters a path of light entering the camera module described with reference to FIGS. 1-2. In this example, a reflective element 600 can be an embodiment of the reflective element 212, and is illustrated as a prism.

In some implementations, the reflective element 600 provides increased reliability over the use of a reflective element embodiment such as a mirror. Prims are solid pieces of transparent material with flat, polished surfaces that refract light. Due to the plurality of optical surfaces of a prism, a prism can be used to replace one or more mirror elements. Additionally, prisms are monolithic—formed from a single block of material—and an appropriately toleranced prism can often avoid common alignment problems faced by similar optical assemblies that use mirror elements. For example, a pentaprism, which has two reflective surfaces oriented at 45°, produces a 90° deviation from the optical axis along which light is incident, regardless of the angle of incidence, whereas mirror elements must be accurately aligned to yield the same result.

The same techniques of using a plurality of actuators, and potentially biasing elements in addition, can be used to make minute adjustments to the tilt of the prism as could be done with a mirror.

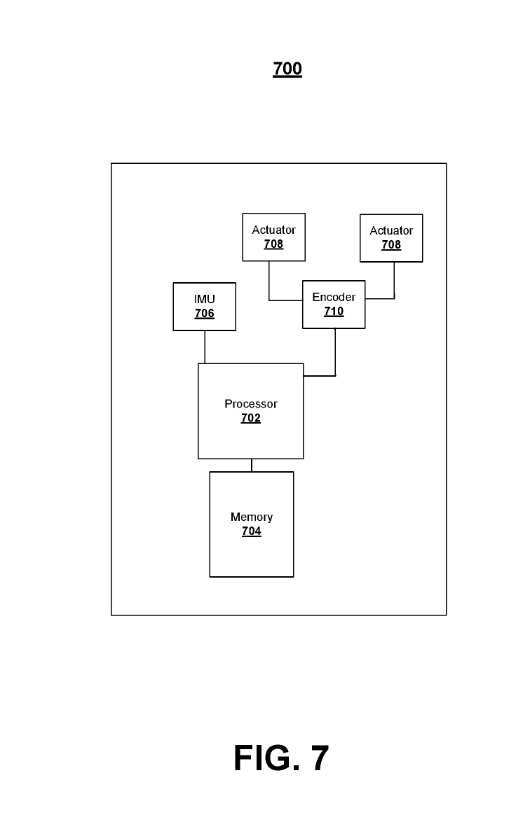

FIG. 7 is a diagram illustrating an example system 700 for controlling the reflective element assemblies described with reference to FIGS. 3A-6. The system 700 includes a processor 702, a memory 704, an inertial measurement unit (IMU) 706, actuators 708, and an encoder 710. Each of the processor 702, the memory 704, the IMU 706, the actuators 708, and the encoder 710, are interconnected using various buses, and may be mounted on a common motherboard or in other manners as appropriate.

The processor 702 can process instructions for execution within the system 700, including instructions stored in the memory 704 to control the actuators 708 and process measurements taken by the IMU 706 and the encoder 710.

The IMU 706 is an electronic device that measures and reports a body's specific force, angular rate, and magnetic field surrounding the body, using a combination of accelerometers, gyroscopes, and magnetometers. The IMU 706 measures the movement of a camera module that houses the system 700 (e.g., the camera module 150). The IMU 706 provides the movement data to the processor 702. For example, if the camera module 150 is moved to produce a tilt 0.0° about the x axis of the camera module 150 and −0.8° about the y axis of the camera module 150, the IMU 706 can measure and report the movement of the camera module 150 to the processor 702.

The actuators 708 can be an embodiment of the actuators 302a-302b described with reference to FIGS. 3A-5B. The actuators 708 are connected to the encoder 710 which converts information from one format to another and provides position and/or speed feedback. The actuators 708 are controlled by the processor 702 through instructions received from the processor 702.

The encoder 710 can provide position and/or velocity feedback, such as an encoder that measure displacement using a piezoelectric, linear, optical, Hall effect, or other mechanism. The encoder 710 measures and reports movement data of the actuators 708 to provide feedback to the processor 702 during the control of the actuators. For example, the processor 702 can issue a command to the actuators 708, and the actuators 708 can respond and begin to react, but may not reach the full commanded actuation before the processor 702 receives another input from the IMU 706 indicating a new compensation needed. In this example, the encoder 710 provides feedback of the current position and velocity of the actuators 708 to the processor 702, and allows the processor 702 to incorporate the current position of the actuators 708 as well as the expected trajectory of the actuators 708 into the calculations for a next compensation for movement of the camera module 150.

Traditional autofocusing cameras have VCM closed loop feedback systems that use Hall effect sensors, but this system presents a packaging problem—it is difficult to house the VCM actuators while maintaining a thin form factor. The proposed system allows use of a closed loop feedback system in a smaller package. By tilting the reflective element of the camera module to compensate for image shift instead of linearly translating the entire camera module, the proposed system reduces an amount of space in the z direction of the camera module needed. Necessary stroke range of actuators, as well as the size of the actuators themselves is reduced; the orientation of the actuators (from along the x-axis and along the z-axis to along the x-axis and along the y-axis) is changed as well. Thus, the independently controlled actuator system provides OIS in a thinner package. In some implementations, the system 700 can use a look up table to determine compensations needed for the movement of the camera module 150. In some implementations, the system 700 can a closed loop feedback technique. In some implementations, the system 700 can be an open loop feedback system.

The processor 702 receives input from the IMU 706 of camera module movement. For example, the processor 702 can receive movement data from the IMU 706 indicating that the camera module 150 has tilted 0.6° about the x axis and 0.1° about the y axis. The processor 702 then determines a compensation needed to counteract the movement of the camera module 150 based on the input from the IMU 706. For example, the processor 702 can determine that the reflective element 212 needs to be tilted such that θx=−0.3° and θy=−0.1°. The processor 702 can then control the actuators 708 to produce the calculated tilt compensation.

The processor 702 receives feedback from the encoder 710 of the actual movement of the actuators 708, and can use the feedback along with the movement data received from the IMU 706 to determine a next compensation needed.

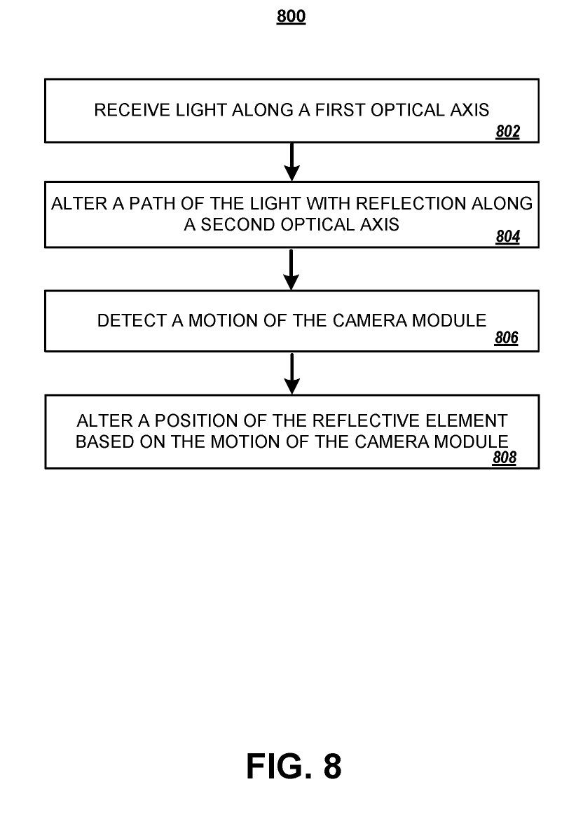

FIG. 8 is a flowchart illustrating an example process in which the reflective element assemblies described with reference to FIGS. 3A-6 alter a path of light entering the camera module described with reference to FIGS. 1-2. Briefly, according to an example, the process 800 includes receiving light along a first optical axis (802). For example, a camera module (e.g., the camera module 150) can receive light along a first optical axis. The process 800 includes altering a path of the light with reflection along a second optical axis (804). For example, the camera module can include a reflective element assembly 210 that reflects the incident light along a second optical axis. The process 800 continues with detecting a motion of a camera module (e.g., the camera module 150) (806). For example, the camera module 150 can include a system 700 that detects a movement of the camera module 150. The process 800 concludes with altering a position of the reflective element based on the motion of the camera module (808). For example, the system 700 of the camera module 150 can determine a compensation for the movement of the camera module 150 based on the movement data and control one or more independently controlled actuators to tilt a reflective element 212 of the reflective element assembly 210.

A number of implementations have been described. Nevertheless, it will be understood that various modifications may be made without departing from the spirit and scope of the disclosure. For example, various operations discussed above may be used, with steps re-ordered, added, or removed.

All of the functional operations described in this specification may be implemented in digital electronic circuitry, or in computer software, firmware, or hardware, including the structures disclosed in this specification and their structural equivalents, or in combinations of one or more of them. The techniques disclosed may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single embodiment. Conversely, various features that are described in the context of a single embodiment can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As used herein, components that are coupled together may be electrically connected in a manner that allows electrical communication between them. Thus coupled components may be connected directly, e.g., by a wire, solder, circuit board trace, or other conductor, or indirectly through one or more other intervening circuit components.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Particular implementations of the invention have been described. Other implementations are within the scope of the following claims. For example, the steps recited in the claims can be performed in a different order and still achieve desirable results.

What is claimed is:

1. A camera module comprising:
an image sensor;
a lens assembly comprising a first portion configured to receive light along a first optical axis and a second portion that includes a plurality of lens elements that share a second optical axis that is different from the first optical axis;
a reflective element arranged to alter a path of light entering the camera in a direction along the first optical axis to a direction along the second optical axis;
at least two independent actuators configured to tilt the reflective element about a pivot point; and
one or more resilient elements configured to bias a position of the reflective element.

2. The camera module of claim 1, wherein the reflective element is a mirror.

3. The camera module of claim 2, wherein the one or more resilient elements are configured to exert a force on the reflective element to return the reflective element to a neutral position in which the reflective element is arranged at a 45° angle with respect to the first optical axis.

4. The camera module of claim 1, wherein the reflective element is a prism.

5. The camera module of claim 1, wherein the at least two independent actuators are configured to provide optical image stabilization to the camera.

6. The camera module of claim 1, wherein the at least two independent actuators are voice coil motor actuators.

7. The camera module of claim 1, wherein the at least two independent actuators are piezoelectric actuators.

8. The camera module of claim 7, wherein the at least two independent actuators provide an active biasing toward the center of the reflective element, wherein the at least two independent actuators locate the reflective element to provide the pivot point, wherein the pivot point is not supported by a physical support, and wherein the camera does not comprise resilient elements.

9. The camera module of claim 1, wherein the at least two independent actuators are three independent actuators, spaced apart equally around the edge of the reflective element.

10. The camera module of claim 1, wherein the camera comprises:
two independent actuators positioned on orthogonal axes; and
two resilient elements;
wherein each of the two resilient elements is positioned opposite one of the two independent actuators.

11. The camera module of claim 1, further comprising:
an inertial measurement unit (IMU) configured to generate motion data indicating motion of the camera; and
a processor configured to receive the motion data and generate control signals for the at least two actuators in response to the motion data,
wherein the processor is further configured to provide the control signals to the at least two independent actuators to cause the at least two independent actuators to tilt the reflective element to alter an optical path through the camera to compensate for the motion of the camera.

12. The camera module of claim 1, further comprising:
a Hall effect sensor configured to detect movement of the camera; and
at least one linear encoder for each of the at least two independent actuators,
wherein the at least one linear encoder is configured to detect movement of each of the independent actuators.

13. The camera module of claim 1, wherein the reflective element is arranged to alter the path of light to remain within a predetermined length along the direction of the first optical axis.

14. The camera module of claim 1, wherein the pivot point is a virtual pivot point not supported or located by a physical pivot element configured to engage the reflective element.

15. The camera module of claim 14, further comprising:
one or more flexible elements arranged to provide support to the reflective element,
wherein the reflective element is mounted within the camera using the flexible elements,
wherein the elements are arranged around the edge of the reflective element, wherein the flexible elements allow the reflective element to tilt around the virtual pivot point, and
wherein the flexible elements are the resilient elements that provide the biasing of the reflective element.

16. The camera module of claim 1, wherein the pivot point is located at a center of the reflective element.

17. The camera module of claim 16, wherein the pivot point is supported by a mechanical pivot element located at the back side of the reflective element, wherein the mechanical pivot element is configured to engage the reflective element at the back side of the reflective element.

18. The camera module of claim 1, wherein the reflective element has a stiffness such that its resonant frequency is above 200 Hz.

19. A method of performing optical image stabilization in a camera, the method comprising:
receiving light along a first optical axis of a camera, the camera comprising:
an image sensor;
a lens assembly comprising a first portion configured to receive light along the first optical axis and a second portion that includes a plurality of lens elements that share a second optical axis that is different from the first optical axis;
a reflective element arranged to alter a path of light entering the camera in a direction along the first optical axis to a direction along the second optical axis;
at least two independent actuators configured to tilt the reflective element about a pivot point; and
one or more resilient elements to bias a position of the reflective element;
altering, by the reflective element, a path of light entering the camera in a direction along the first optical axis to a direction along the second optical axis;
detecting a motion of the camera using the image sensor of the camera; and
altering, by the at least two independent actuators and two resilient members, a tilt of the reflective element about the pivot point based on the detected motion of the camera.

20. A mobile device comprising:
a processor;
a storage device; and
a camera module coupled to the processor, wherein the camera module comprises:
an image sensor;
a lens assembly comprising a first portion configured to receive light along a first optical axis and a second portion that includes a plurality of lens elements that share a second optical axis that is different from the first optical axis;
a reflective element arranged to alter a path of light entering the camera in a direction along the first optical axis to a direction along the second optical axis;
at least two independent actuators configured to tilt the reflective element about a pivot point; and
one or more resilient elements configured to bias a position of the reflective element.
